(19) United States
(12) Patent Application Publication
(10) Pub. No.: US 2008/0046973 A1
(43) Pub. Date: Feb. 21, 2008

(54) Preventing Unauthorized Access of Computer Network Resources

(76) Inventor: Jens-Christian Jorgensen, Rodovre (DK)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/570,563

(22) PCT Filed: Jun. 29, 2004
(86) PCT No.: PCT/EP04/51290

§ 371 Date: Oct. 30, 2006

(30) Foreign Application Priority Data
Aug. 28, 2003 (GB) 0320057.3

(51) Int. Cl. G06F 7/04

(52) U.S. Cl. 726/4

(57) ABSTRACT

A computer network security system comprising a network transport device, a Domain Controller, at least one network resource and at least one client operably connected as to form a computer network wherein a means for monitoring authentication of said client to said Domain Controller is connected between said network transport device and said client.

### FIELD OF THE INVENTION

The present invention relates to data security systems, in general, and to a system and a method for preventing unauthorized access of network resources, in particular.

### BACKGROUND OF THE INVENTION

With the advent of computer networks and the Internet in particular, computer users connected to these networks have access to a wide variety of resources. These resources are documents, files, technical and financial data as well as other electronic content. From one point of view such remote or local access to resources gives a possibility to use these resources independently from their location. From another point of view, as these resources in most cases are vital for their proprietors, it introduces a risk when they are accessed by someone who was not authorized.

From a technical point of view these resources are provided by network servers, which operate under control of operating systems. A remote or local client, which needs access to a resource sends a request to the server and, in response, the server sends the resource (gives access) to the remote or local client. As most of the resources are valuable and important they can be accessed only by authorized remote or local clients. One method of authentication of the remote or local client is a requirement of correct entry of the user's name and password. Only those remote or local clients, which pass the authentication, can access the resource. A username-password scheme is an authentication mechanism that enables a server to restrict access to particular clients (users).

However it quite often happens that in one computer network different network resources work under control of different operating systems. In such situations the problem is that remote or local clients which connect to the Domain Controller, when they are logging on to the domain controlled by the Domain Controller, can by-pass the Domain Controller if the client installation is not an authorised Windows, NT/2000, client installation.

This will give the unauthorised remote or local client access to network resources—e.g. UNIX servers, which are not controlled for authentication by the Windows NT/2000 Domain controller—without logging on to on the Domain Controller at session start up.

One solution known in the art, a so-called Remote Access Server (RAS), which performs authentication of the remote client, can be situated on the path between the remote client and the domain controller. The RAS after the authentication phase gives access to the network and not only the Domain Controller. This means that the Domain Controller can be by-passed after the remote client has been authenticated by the RAS. However from the point of view of network safety Domain Controller shall authenticate and authorise all sessions initiated by remote or local clients in order to place all the authentication process on one server.

### SUMMARY OF THE INVENTION

There is a need for a computer network security system and a method for preventing unauthorized access of network resources, which alleviate or overcome the disadvantages of the prior art.

According to a first aspect of the present invention there is thus provided a computer network security system as claimed in claim 1.

According to a second aspect of the present invention there is thus provided a method for preventing unauthorized access of computer network resources as claimed in claim 11.

The present invention beneficially allows:

1. Reduction of network traffic between clients and servers which traverse the Domain Controller.

2. It is possible to take over the functions of the primary Domain Controller when it does not work by the backup Domain Controller.

3. Remote or local connected clients to the Domain Controller site, which shall be authenticated by Domain Controller, can be situated anywhere compared to Domain Controller site.

### BRIEF DESCRIPTION OF THE DRAWINGS

The present invention will be understood and appreciated more fully from the following detailed description of embodiments taken in conjunction with the drawings in which:

FIG. 1 is a block diagram of a computer network security system in one embodiment of the present invention,

FIG. 2 is a block diagram of a computer network security system in second embodiment of the present invention,

FIG. 3 is a block diagram of a computer network security system in third embodiment of the present invention

FIG. 4 is a flow chart illustrating a method for preventing unauthorized access of computer network resources in one embodiment of the present invention,

### DETAILED DESCRIPTION OF AN EMBODIMENT OF THE INVENTION

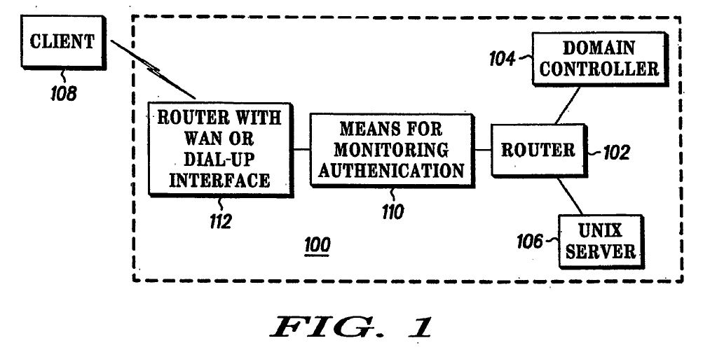

Referring to FIG. 1 one embodiment of a computer network security system 100 according to the present invention is shown. A computer network security system 100 comprises a network transport device 102, which is responsible for directing data packets to their destination IP addresses. In one embodiment said network transport device 102 can be a router and in another embodiment it can be a switch. Said network transport device is connected to a Domain Controller (also referred to as DC) 104 and to an UNIX server 106. A client 108 is operably connected to a means for monitoring authentication 110, which is connected to said network transport device 102. If said client 108 is located remotely from a domain controlled by said Domain Controller 104 said client is connected to said means for monitoring authentication 110 via router with WAN or dial-up interface.

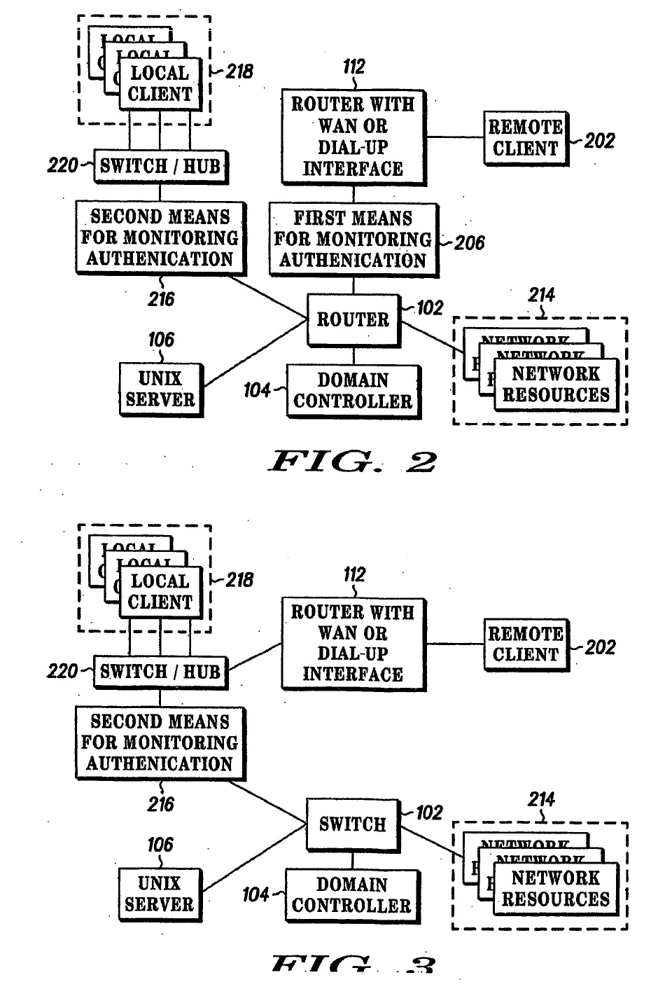

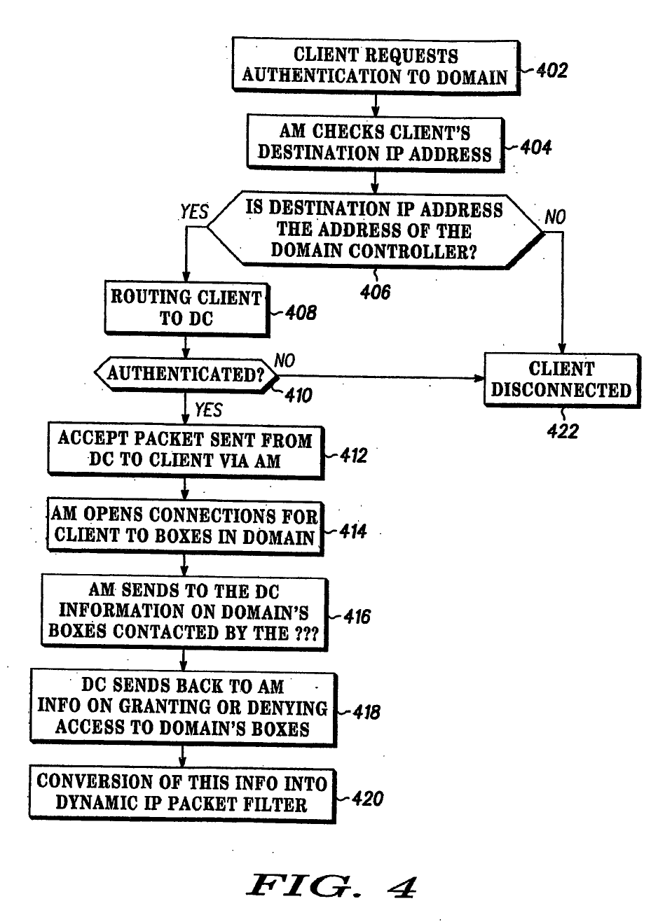

Referring to FIGS. 2 and 3 another embodiment of said computer network security system is depicted. If at least one client is located within a domain controlled by said Domain Controller (local client 218) and at least one client is located remotely (remote client 202) said local client 218 is connected to a second means for monitoring authentication 216 via a switch or a hub 220 and said remote client is connected to a first means for monitoring authentication 206 via a router with WAN or dial-up interface 112. Alternatively if only one means for monitoring authentication is shared in the domain said router with WAN or dial-up interface 112 is connected to switch or said hub 220.

If said domain controller 104 and said UNIX server 106 work under control of different operating system then access to said UNIX server 106 is not controlled for authentication by said Domain Controller 104. When the client 108 is initiating a session to a server 108 or host within a domain under control of a domain controller 104 said client 108 is directed by a means for monitoring authentication 110, basing on destination IP address, to said domain controller 104. Said client 108 is authenticated by said Domain Controller 104 before access to network resources within said domain is granted or denied. Before authentication said means for monitoring authentication 110 allow for connection only with said Domain Controller 104.

With reference to FIG. 4 a method for preventing unauthorized access of computer network resources is presented in one embodiment. On FIG. 4 said means for monitoring authentication is referred to as “AM”. At the time of initiation of a session said client 108 requests authentication 402 to said domain controlled by said Domain Controller 104.

Said means for monitoring authentication 110 checks an IP destination address 404 of said client 108 to prevent accessing network resources which are not controlled for authentication. Only those clients whose IP destination addresses are that of said Domain Controller 406 are routed 408 to said Domain Controller 104 for authentication. If prior to authentication the destination IP address of said client 108 is not the one of said Domain Controller 104 said means for monitoring authentication 110 changes said destination IP address and allows routing to said Domain Controller 104 only.

The authentication process can be based on encryption mechanism agreed between said client 108 and said domain controller 104. If said client is authenticated 410 an acceptance packet is sent 412 from said Domain Controller 104 to said client 108 via said means for monitoring authentication 110. Based on this information said means for monitoring authentication 110 opens connections 414 for said client to network resources in said domain. In consequence the path for that session is not limited to the path between the Domain Controller 104 and the client 108 but also other servers 106 and 214 can be contacted by said client 108 during that session. Said means for monitoring authentication 110 keeps track of the session based on the encryption algorithm and keys for that session. The authentication mechanism based on encryption and used by said means for monitoring authentication 110, takes place on the path between said means for monitoring authentication 110 and said client 108 only. It is because e.g. UNIX servers and other network devices that the client 108 accesses may not have that encryption mechanism in place.

Said means for monitoring authentication 110 disconnects 422 said client 108 if said authentication failed or is not performed in predetermined period of time.

To keep control over the client connected to the domain said means for monitoring authentication 110 sends 416 to said Domain Controller 104 information on said network resources contacted by said client. Said means for monitoring authentication collects IP addresses and UDP/TCP port numbers contacted by said client 108 and this information is sent 416 to said Domain Controller 104. In response said Domain Controller 104 sends 418 to said means for monitoring authentication 110 information on granting or denying access to said network resources. Said means for monitoring authentication converts 420 said information on granting or denying access into dynamic IP packet filter. Said means for monitoring authentication 110 disconnects said client 108 if said client attempts to connect to network resources which said client is not authorised to.

Access to said network resources 214 is maintained as long as session initiated during authentication is active. Said means for monitoring authentication 110 determines if the session belongs to said client 108 based on said client's 108 source IP address and encryption mechanism.

To provide security of the computer network a standard encryption of client's 108 password used during authentication is performed by already implemented feature in said Domain Controller 104 and a client. In case of Domain Controller run under Windows NT/2000 the encryption mechanism takes place between the client and the Domain Controller so the authentication process is trusted. I.e. it is very difficult to copy this process for a client which is not the right client.

And for encryption of a session between said client 108 and said network resource, which is not controlled by said Domain Controller 104, a Virtual Private Network tunnel is used. Said Virtual Private Network tunnel is established between said client 108 and said means for monitoring authentication 110 or an access point on a local area network, e.g. router with WAN interface 112.

In one embodiment, the means for monitoring authentication 110 is implemented in software executable on said network transport device 102 (e.g. router). A software implementation is relatively low cost and allows easy reconfiguration. However hardware implementation is also possible. Nevertheless, it will be appreciated that the present invention may be implemented hardware or software and may be used in computer networks.

It is worth emphasising that embodiments of the present invention allows for authentication of clients that attempting to access network resources operating under control of different operating systems within one domain. Additionally all the authentication process and all information related to said network resources contacted by said client are placed on one server.

1. A computer network security system comprising, operably connected as to form a computer network, a network transport device, a Domain Controller, at least one network resource in a domain controlled by the Domain Controller, at least one client and, connected between said network transport device and said client, means for authentication of said client to said Domain Controller; wherein when the client requests authentication to a domain controlled by the Domain Controller the means for monitoring authentication is operable to check an IP destination address indicated by said client and if said IP destination address is that of said Domain Controller the means for monitoring is operable to route the client to said Domain Controller for authentication; if said client is authenticated by the Domain Controller the Domain Controller is operable to send an acceptance data packet to said client via said means for monitoring authentication; and in response to receiving the acceptance data packet the means for monitoring authentication is operable to open connection for said client to said at least one network resource.

2. The computer network security system according to claim 1, wherein access to said network resource is not controlled for authentication by said Domain Controller.

3. The computer network security system according to claim 1, wherein said means for monitoring authentication comprising a means for disconnecting said client if said authentication failed.

4. The computer network security system according to claim 3, wherein said means for monitoring authentication comprising a means for disconnecting said client if said authentication is not performed in predetermined period of time.

5. The computer network security system according to claim 1, wherein said means for monitoring authentication comprising a means for disconnecting said client if said client attempts to connect to network resource which said client is not authorised to.

6. The computer network security system according to claim 1, wherein a second network transport device equipped with WAN or dial-up interface is connected between said client and said means for monitoring authentication.

7. The computer network security system according to claim 1, wherein said network transport device is a router.

8. The computer network security system according to claim 1, wherein said network transport device is a switch.

9. The computer network security system according to claim 1, wherein said client is located remotely.

10. The computer network security system according to claim 1, wherein said client is located within a domain controlled by said Domain Controller.

11. A method for preventing unauthorized access of computer network resources comprising the steps:
a) a client requests authentication to a domain controlled by a Domain Controller;
characterized in that
b) a means for monitoring authentication checks an IP destination address of said client;
c) if said IP destination address is that of said Domain Controller said client is routed to said Domain Controller for authentication;
d) if said client is authenticated an acceptance packet is sent from said Domain Controller to said client via said means for monitoring authentication;
e) said means for monitoring authentication opens connections for said client to network resources in said domain.

12. The method according to claim 11 further comprising the steps:
f) said means for monitoring authentication sends to said Domain controller information on said network resources contacted by said client;
g) said Domain Controller sends to said means for monitoring authentication information on granting or denying access to said network resources;
h) said means for monitoring authentication converts said information on granting or denying access into dynamic IP packet filter.

13. The method according to claim 11 wherein said routing is done by permitting a route to only Domain Controller IP address.

14. The method according to claim 11, wherein for identification of said network resources IP addresses or UDP/TCP port numbers are used.

15. The method according to claim 11, wherein said means for monitoring authentication disconnects 422 said client if said authentication failed.

16. The method according to claim 11, wherein said means for monitoring authentication disconnects 422 said client if said authentication is not performed in a predetermined period of time.

17. The method according to claim 11, wherein said means for monitoring authentication disconnects said client if said client attempts to connect to network resources which said client is not authorised to connect to.

18. The method according to claim 11, wherein access to said network resources is maintained as long as a session initiated during authentication is active.

19. The method according to claim 11, wherein for encryption of a session between said client and said network resource, which is not controlled by said Domain Controller, a Virtual Private Network tunnel is used.

20. The method according to claim 19, wherein said Virtual Private Network tunnel is established between said client and said means for monitoring authentication.

21. The method according to claim 18, wherein said means for monitoring authentication determines if the session belongs to said client based on said client's source IP address and encryption mechanism.

22. The method according to claim 20, wherein said Virtual Private Network tunnel is established between said client and an access point on a local area network.

23. The method according to claim 11, wherein access to at least portion of said network resources is not controlled for authentication by said Domain Controller.

24. A router or switch adapted to perform the method steps of claim 11.
